(19) United States
(12) Patent Application Publication
(10) Pub. No.: US 2014/0045110 A1
(43) Pub. Date: Feb. 13, 2014

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Keiko MATSUKI, Kanagawa (JP); Takayuki YAMASHITA, Kanagawa (JP); Yoshifumi SHOJI, Kanagawa (JP); Mitsuhide NAKAMURA, Kanagawa (JP); Yuko YAMANO, Kanagawa (JP); Shinya YAMAMOTO, Kanagawa (JP)

(73) Assignee: FUJI XEROX CO., LTD., Tokyo (JP)

(21) Appl. No.: 13/777,367

(22) Filed: Feb. 26, 2013

(30) Foreign Application Priority Data
Aug. 10, 2012 (JP) 2012-179075

(51) Int. Cl. G03G 15/00

(52) U.S. Cl. CPC G03G 5/08
USPC 430/56; 399/159; 430/69; 430/63

(57) ABSTRACT

An electrophotographic photoreceptor includes a cylindrical conductive substrate that is formed of a metal or an alloy and has an average area of crystal grains of 100 μm² or greater; and a photosensitive layer that is provided on the conductive substrate.

### CROSS-REFERENCE TO RELATED APPLICATIONS

This application is based on and claims priority under 35 USC 119 from Japanese Patent Application No. 2012-179075 filed Aug. 10, 2012.

### BACKGROUND

1. Technical Field

The present invention relates to an electrophotographic photoreceptor, a process cartridge, and an image forming apparatus.

2. Related Art

An electrophotographic image forming apparatus can form a high-quality image at high speed, and is used as an image forming apparatus such as a copying machine or a laser beam printer. An organic photoreceptor using an organic photoconductive material is widely used as a photoreceptor of the image forming apparatus. When the organic photoreceptor is prepared, there are many cases where, for example, an undercoat layer (sometimes referred to as an interlayer) is formed on an aluminum substrate and then a photosensitive layer, in particular, a photosensitive layer including a charge generation layer and a charge transport layer is formed thereon.

### SUMMARY

According to an aspect of the invention, there is provided an electrophotographic photoreceptor including a cylindrical conductive substrate that is formed of a metal or an alloy and has an average area of crystal grains of 100 μm² or greater; and a photosensitive layer that is provided on the conductive substrate.

### BRIEF DESCRIPTION OF THE DRAWINGS

Exemplary embodiments of the present invention will be described in detail based on the following figures, wherein:

FIG. 1 is a diagram schematically illustrating a layer configuration example of an electrophotographic photoreceptor according to an exemplary embodiment of the invention;

FIG. 2 is a diagram schematically illustrating another layer configuration example of the electrophotographic photoreceptor according to the exemplary embodiment;

FIG. 3 is a diagram schematically illustrating another layer configuration example of the electrophotographic photoreceptor according to the exemplary embodiment;

FIG. 4 is a diagram schematically illustrating another layer configuration example of the electrophotographic photoreceptor according to the exemplary embodiment;

FIG. 5 is a diagram schematically illustrating another layer configuration example of the electrophotographic photoreceptor according to the exemplary embodiment;

FIG. 6 is a diagram schematically illustrating another layer configuration example of the electrophotographic photoreceptor according to the exemplary embodiment; and

FIG. 7 is a diagram schematically illustrating a configuration of an image forming apparatus according to an exemplary embodiment of the invention.

### DETAILED DESCRIPTION

Hereinafter, exemplary embodiments which are examples of the invention will be described.

### Electrophotographic Photoreceptor

An electrophotographic photoreceptor (hereinafter, sometimes simply referred to as “a photoreceptor”) according to an exemplary embodiment of the invention includes a conductive substrate and a photosensitive layer that is formed on the conductive substrate.

The conductive substrate described herein is a cylindrical conductive substrate that is formed of a metal or an alloy and has an average area of crystal grains of 100 μm² or greater.

In the electrophotographic photoreceptor according to the exemplary embodiment having the above-described configuration, the peeling of layers (for example, an undercoat layer or a photosensitive layer) formed on the conductive substrate is suppressed.

The reason is not clear, but is considered to be as follows.

The cylindrical conductive substrate that is formed of a metal or an alloy may be plastically deformed by the effect of heating. When the conductive substrate is plastically deformed, layers (for example, an undercoat layer and a photosensitive layer) formed on the conductive substrate are easily peeled off.

In particular, a reduction in the thickness of the cylindrical conductive substrate, formed of a metal or an alloy, is preferable from the viewpoints of reducing the weight of, for example, an electrophotographic photoreceptor or an image forming apparatus (or a process cartridge) having the same and of reducing cost. However, when the thickness of the conductive substrate is thin, the conductive substrate is easily plastically deformed and thus layers (for example, an undercoat layer and a photosensitive layer) formed on the conductive substrate are easily peeled off.

On the other hand, it is considered that, when the average area of crystal grains in the conductive substrate is within the above-described range, the peeling of layers formed on the conductive substrate is suppressed. The reason is considered to be that, when the average area of crystal grains is large in the above-described range, each crystal grain is large, the amount of plastic deformation is small, and the amount of elastic deformation is large.

Therefore, it is considered that the peeling of layers (for example, an undercoat layer and a photosensitive layer) formed on the conductive substrate is suppressed in the electrophotographic photoreceptor according to the exemplary embodiment.

In particular, when an undercoat layer is provided between the conductive substrate and the photosensitive layer, the thickness of the undercoat layer is thinner than that of the photosensitive layer. Therefore, when the conductive substrate is plastically deformed, the undercoat layer is easily peeled off. In the exemplary embodiment, since the plastic deformation of the conductive substrate is suppressed, the peeling of the undercoat layer is easily suppressed.

In addition, when the undercoat layer contains a binder resin and metal oxide particles of which surfaces are treated with a coupling agent having an amino group, the conductive substrate is oxidized by the coupling agent having an amino group and is easily corroded. However, in the exemplary embodiment, the corrosion of the conductive substrate is easily suppressed. The reason is considered to be that, when the average area of crystal grains in the conductive substrate is within the above-described range, there are small grain boundaries between crystal grains in which oxidation, which causes corrosion, easily occurs.

Hereinafter, the electrophotographic photoreceptor according to the exemplary embodiment will be described with reference to the drawings.

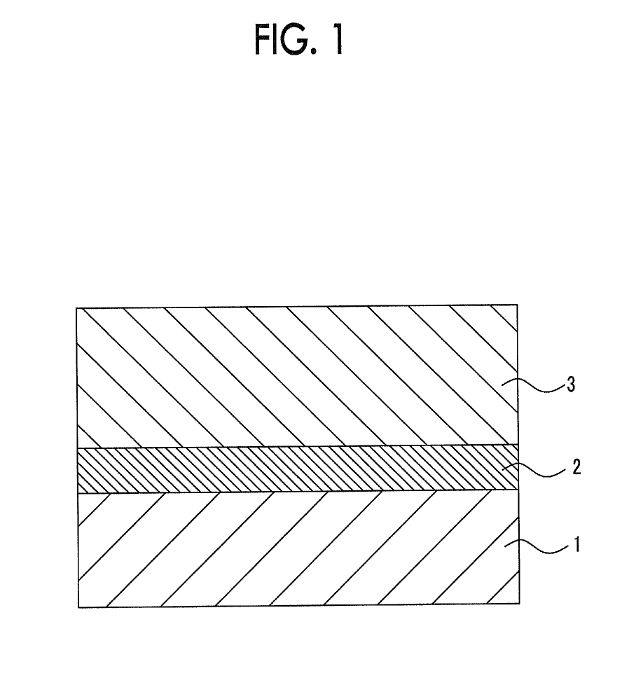

FIGS. 1 to 6 are diagrams schematically illustrating layer configuration examples of the photoreceptor according to the exemplary embodiment. A photoreceptor illustrated in FIG. 1 includes a conductive substrate 1, an undercoat layer 2 formed on the conductive substrate 1, and a photosensitive layer 3 formed on the undercoat layer 2.

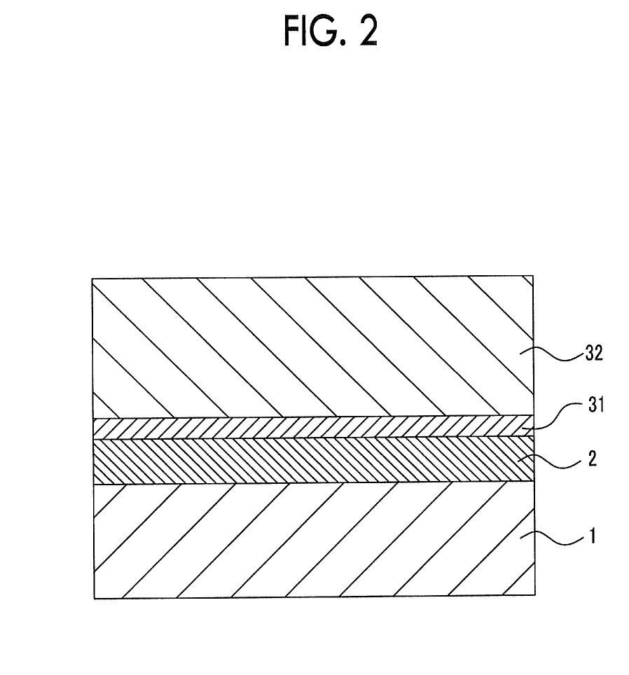

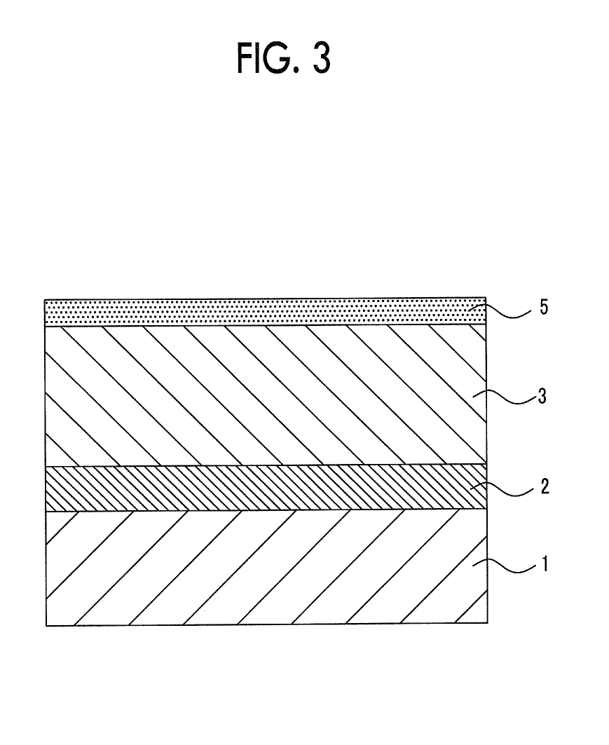

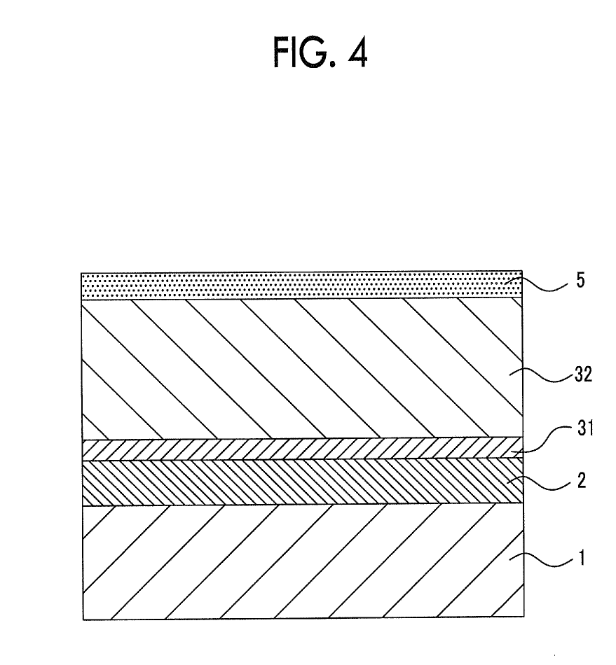

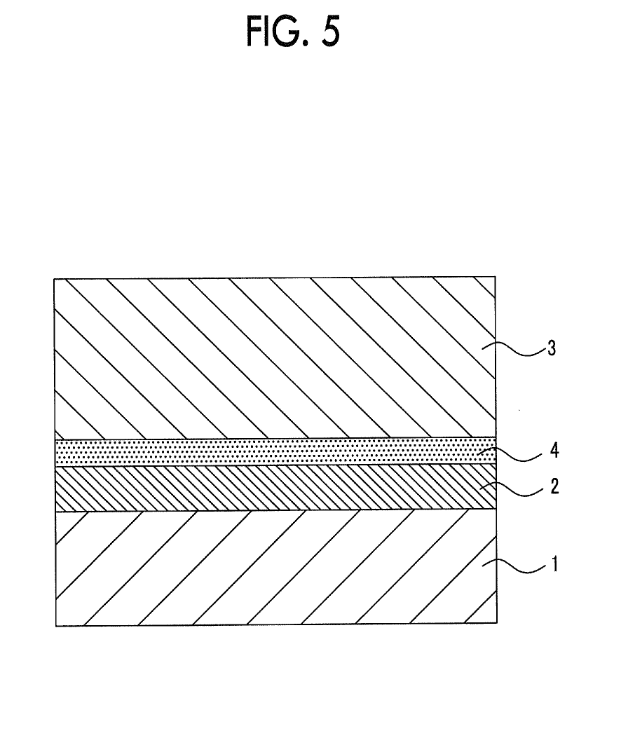

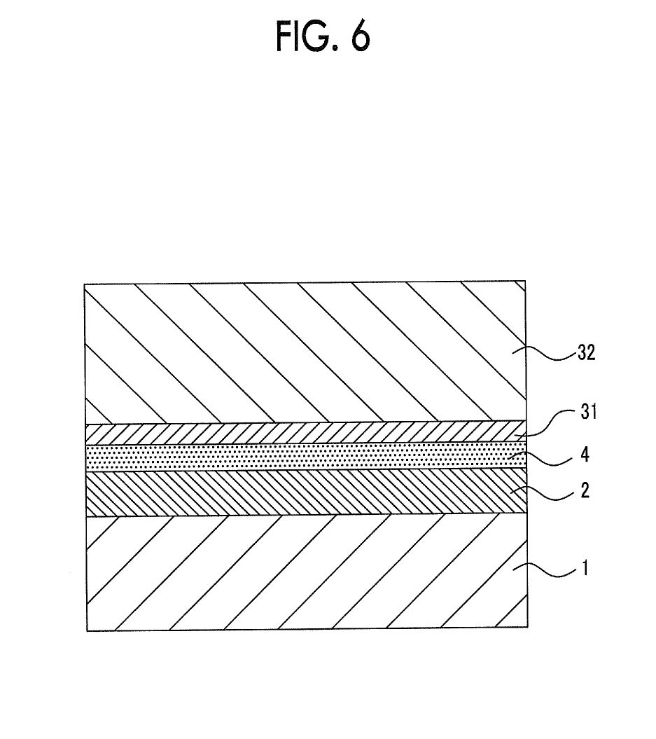

In addition, as illustrated in FIG. 2, the photosensitive layer 3 may have a two-layer structure including a charge generation layer 31 and a charge transport layer 32. Furthermore, as illustrated in FIGS. 3 and 4, a protective layer 5 may be provided on the photosensitive layer 3 or the charge transport layer 32. In addition, as illustrated in FIGS. 5 and 6, an interlayer 4 may be provided between the undercoat layer 2 and the photosensitive layer 3 or between the undercoat layer 2 and the charge generation layer 31.

In the drawings, the interlayer 4 is provided between the undercoat layer 2 and the photosensitive layer 3 or between the undercoat layer 2 and the charge generation layer 31. However, the interlayer 4 may be provided between the conductive substrate 1 and the undercoat layer 2. Of course, the interlayer 4 is not necessarily provided.

Next, the respective elements of the electrophotographic photoreceptor will be described. In the following description, the respective reference numerals will be omitted.

### Conductive Substrate

The average area of crystal grains in the conductive substrate is greater than or equal to 100 μm². However, from the viewpoints of suppressing the peeling of layers formed on the conductive substrate and of the corrosion resistance of the conductive substrate, the average area is preferably greater than or equal to 200 μm² and more preferably greater than or equal to 400 μm². The upper limit of the average area of crystal grains is preferably 1400 μm² (more preferably, 2000 μm² or less) from the viewpoint of the restriction of a preparation method.

A method of measuring the average area of crystal grains is as follows.

First, a layer (for example, a photosensitive layer), formed on an outer peripheral surface of the conductive substrate, is removed from the photoreceptor by a cutter or the like; or is dissolved in a solvent or the like to be removed.

Next, a sample which is obtained by removing the layer, formed on the outer peripheral surface, from the conductive substrate is embedded with an epoxy resin and then is ground by a grinder as described below. First, grinding is performed using waterproof abrasive paper #500, and mirror finishing is performed by buffing. Then, a cross-section of the conductive substrate is observed and measured using VE SEM (manufactured by KEYENCE Corporation)

Specifically, at each of positions 5 mm distant from both ends of the conductive substrate in an axial direction thereof and a central position of the conductive substrate in the axial direction, four samples (Total: 4×3=12 samples) are prepared as described above so as to form 90 degrees between the samples in the circumferential direction.

In the cross-section of each sample, the area of a crystal grain, which is located at a position corresponding to a range of 30 μm×20 μm (axial direction×thickness direction) from the outer peripheral surface of the substrate, is calculated by image processing software installed on the above-described VE SEM (manufactured by KEYENCE Corporation); the areas of crystal grains of the 12 samples are averaged by the number of the samples; and the average value is set as the average area of crystal grains in the conductive substrate.

The conductive substrate is formed of a metal or an alloy. Specific examples of the metal or the alloy include aluminum, copper, magnesium, silicon, zinc, chromium, nickel, molybdenum, vanadium, indium, gold, platinum, stainless steel, and alloys thereof. “Conductive” represents the volume resistivity being less than 10¹³ Ωcm.

Among these, it is preferable that the conductive substrate is formed of aluminum.

In particular, an aluminum substrate having a purity (content of aluminum) of 90% or higher (preferably 95% or higher and more preferably 99.5% or higher) has flexibility and is likely to be uniformly affected by a member (for example, a contact charging member) in contact with the electrophotographic photoreceptor in the process of forming an image. As a result, a desired image is easily obtained.

It is suffice that the shape of the conductive substrate be cylindrical, and the shape may be drum shaped, or belt-shaped.

The outer diameter of the conductive substrate is not particularly limited and may preferably be less than or equal to 30 mm. When the outer diameter of the conductive substrate is less than or equal to 30 mm, the dimension stability is easily secured even in the case of a flexible aluminum substrate having a purity (content of aluminum) of 90% or higher.

The thickness of the conductive substrate is not particularly limited, but is preferably from 0.3 mm to 0.7 mm (more preferably from 0.4 mm to 0.6 mm). Even when the thickness is reduced within the above-described range, the peeling of layers formed on the conductive substrate is suppressed.

The conductive substrate is obtained by extrusion-molding an ingot of a metal or alloy into a cylindrical member. In addition, the conductive substrate may be obtained with a method in which a workpiece formed of a metal or an alloy (hereinafter, sometimes simply referred to as “a slag”) is molded into a cylindrical compact by impact pressing; and the obtained cylindrical compact is ironed to obtain a cylindrical compact having a desired thickness. After impact pressing, the cylindrical compact may be drawn and then ironed.

In order to obtain a conductive substrate having the average area of crystal grains within the above-described range, methods of controlling various conditions are used, for example, controlling homogenizing conditions (heating conditions: temperature and time) of an ingot or slag formed of a metal or an alloy, rolling conditions during the preparation of a slag, conditions of processes (for example, the number of times of drawing and ironing), and annealing conditions (temperature and time) of a cylindrical compact after the processes.

When an ingot or slag is homogenized and annealed at a high temperature for a long time, the average area of crystal grains has a tendency to be increased. In addition, when the number of times of rolling, extrusion-molding, and ironing is increased, the average area of crystal grains has a tendency to be reduced.

The conductive substrate may be subjected in advance to various processes such as mirror-surface cutting, etching, anodic oxidation, rough cutting, centerless grinding, sand blasting, and wet honing.

In addition, when the electrophotographic photoreceptor is used for a laser printer, in order to prevent interference fringes caused when laser light is emitted, it is preferable that a surface of the conductive substrate be roughened so as to have a center line average roughness Ra of from 0.04 μm to 0.5 μm. When Ra is less than 0.04 μm, the surface is close to a mirror surface and an effect of preventing interference is not sufficient. When Ra is greater than 0.5 μm, image quality is rough even in the case of forming a coating film. When a light source which emits incoherent light is used, roughening for preventing interference fringes is not particularly necessary and the light source is preferable from the viewpoints of increasing lifetime because defects, caused by convex and concave portions of a surface of the conductive substrate, are prevented.

### Undercoat Layer

The undercoat layer includes a binder resin and metal oxide particles, and optionally further includes an electron-accepting compound.

### Binder Resin

Examples of the binder resin include polymer resin compounds such as acetal resins (for example, polyvinyl butyral), polyvinyl alcohol resins, caseins, polyamide resins, cellulose resins, gelatins, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol resins, phenol-formaldehyde resins, and melamine resins.

### Metal Oxide Particles

Examples of the metal oxide particles include particles of antimony oxide, indium oxide, tin oxide, titanium oxide, zinc oxide, and the like.

Among these, particles of tin oxide, titanium oxide, and zinc oxide are preferable as the metal oxide particles from the viewpoint of the stability of electrical characteristics.

It is preferable that the metal oxide particles be conductive and have a particle diameter of 100 nm or less, in particular, from 10 nm to 100 nm. The particle diameter described herein represents the average primary particle diameter. The average primary particle diameter of the metal oxide particles is a value observed and measured using a scanning electron microscope (SEM).

When the particle diameter of the metal oxide particles is less than 10 nm, the surface area of the metal oxide particles increases, which may lead to a reduction in the uniformity of a dispersion. On the other hand, when the particle diameter of the metal oxide particles is greater than 100 nm, the particle diameter of secondary or higher-order particles is expected to be about 1 μm. Therefore, in the undercoat layer, a so-called sea-island structure having a portion in which there are metal oxide particles and a portion in which there are no metal oxide particles is likely to be generated. As a result, image defects such as unevenness in half-tone density may be generated.

It is preferable that the metal oxide particles have a powder resistance of from 10⁴ Ω·cm to 10¹⁰ Ω·cm. As a result, the undercoat layer may easily have an appropriate impedance at a frequency corresponding to an electrophotographic process speed.

When the resistance value of the metal oxide particles is less than 10⁴Ω·cm, the dependence of impedance on the amount of particles added is too large. As a result, the control of impedance may be difficult. On the other hand, when the resistance value of the metal oxide particles is greater than 10¹⁰ Ω·cm, the residual potential may increase.

Optionally, in order to improve various characteristics such as dispersibility, surfaces of the metal oxide particles may preferably be treated with at least one kind of coupling agent.

The coupling agent may preferably be at least one kind selected from silane coupling agents, titanate coupling agents, and aluminate coupling agents. Among these, a coupling agent having an amino group is preferable from the viewpoints of blocking capability at a boundary between the undercoat layer and the photosensitive layer (for example, the charge generation layer) and a resistance adjusting function of the undercoat layer.

Specific examples of the coupling agent include silane coupling agents such as vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, gamma-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; aluminate coupling agents such as acetoalkoxyaluminum diisopropylate; and titanate coupling agents such as isopropyl triisostearoyl titanate, bis(dioctyl pyrophosphate), and isopropyltri(N-aminoethyl-aminoethyl)titanate. However, the coupling agent is not limited thereto. In addition, a mixture of two or more kinds among these coupling agents may be used.

The amount of the coupling agent used for the treatment is preferably from 0.1% by weight to 3% by weight, more preferably 0.3% by weight to 2.0% by weight, and still more preferably 0.5% by weight to 1.5% by weight with respect to the metal oxide particles.

The amount of the coupling agent used for the treatment is measured as follows.

Examples of a measurement method include various analysis methods such as FT-IR, 29Si solid-state NMR, heat analysis, or XPS. Among these, FT-IR is the simplest method. A well-known KBr tablet method or an ATR method may be used for FT-IR. The amount of the coupling agent used for the treatment is measured by mixing a small amount of metal oxide particles after the treatment with KBr and measuring FT-IR.

After the surface treatment with the coupling agent, the metal oxide particles may be optionally heated for improving the environmental dependence of the resistance value or the like. For example, preferably, the heating temperature is from 150° C. to 300° C. and the heating time is from 30 minutes to 5 hours.

The content of the metal oxide particles is preferably 30% by weight to 60% by weight and more preferably 35% by weight to 55% by weight from the viewpoints of maintaining electrical characteristics.

### Electron-Accepting Compound

The electron-accepting compound is a material which is chemically reactive with the surfaces of the metal oxide particles included in the undercoat layer; or a material which adsorbs onto the surfaces of the metal oxide particles. The electron-accepting compound may be selectively present on the surfaces of the metal oxide particles.

As the electron-accepting compound, an electron-accepting compound having an acidic group may be used. Examples of the acidic group include a hydroxyl group (phenol hydroxyl group), a carboxyl group, and a sulfonyl group.

Specific examples of the electron-accepting compound include quinone compounds, anthraquinone compounds, coumarin compounds, phthalocyanine compounds, triphenylmethane compounds, anthocyanin compounds, flavone compounds, fullerene compounds, ruthenium complex compounds, xanthene compounds, benzoxazine compounds, and porphyrin compounds.

In particular, as the electron-accepting compound, an anthraquinone material (an anthraquinone derivative) is preferable and a compound represented by Formula (1) is more preferable, from the viewpoints of suppressing ghosting and improving the stability, availability, and electron transport capability of the material.

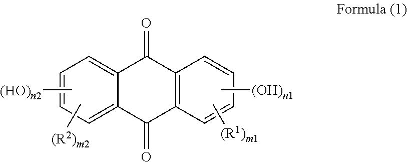

In Formula (1), n1 and n2 each independently represent an integer of from 1 to 3. m1 and m2 each independently represent an integer of 0 or 1. R¹ and R² each independently represent an alkyl group having from 1 to 10 carbon atoms or an alkoxy group having from 1 to 10 carbon atoms.

In addition, the electron-accepting compound may be a compound represented by Formula (2).

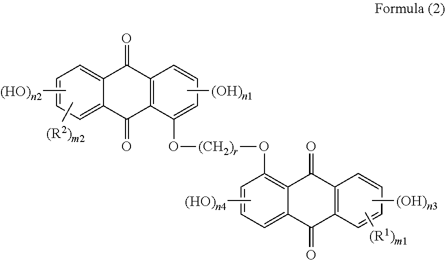

In Formula (2), n1, n2, n3, and n4 each independently represent an integer of from 1 to 3. m1 and m2 each independently represent an integer of 0 or 1. r represents an integer of from 2 to 10. R¹ and R² each independently represent an alkyl group having from 1 to 10 carbon atoms or an alkoxy group having from 1 to 10 carbon atoms.

Examples of the alkyl group having from 1 to 10 carbon atoms represented by R¹ and R² in Formulae (1) and (2) include a methyl group, an ethyl group, a propyl group, and an isopropyl group which may be linear or branched. As the alkyl group having from 1 to 10 carbon atoms, an alkyl group having from 1 to 8 carbon atoms is preferable and an alkyl group having from 1 to 6 carbon atoms is more preferable.

Examples of the alkoxy group (alkoxyl group) having from 1 to 10 carbon atoms represented by R¹ and R² include a methoxy group, an ethoxy group, a propoxy group, and an isopropoxy group which may be linear or branched. As the alkoxy group having from 1 to 10 carbon atoms, an alkoxy group having from 1 to 8 carbon atoms is preferable and an alkoxy group having from 1 to 6 carbon atoms is more preferable.

Specific examples of the electron-accepting compound are shown below, but the electron-accepting compound is not limited thereto.

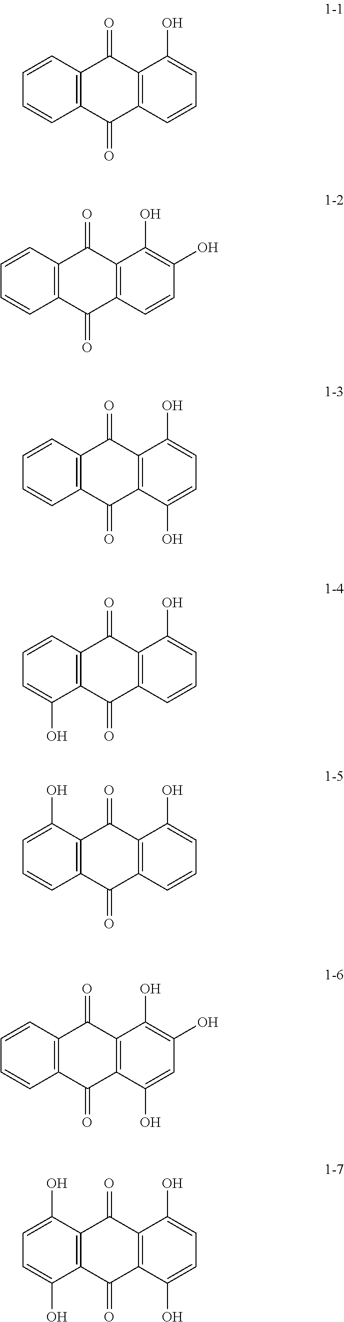

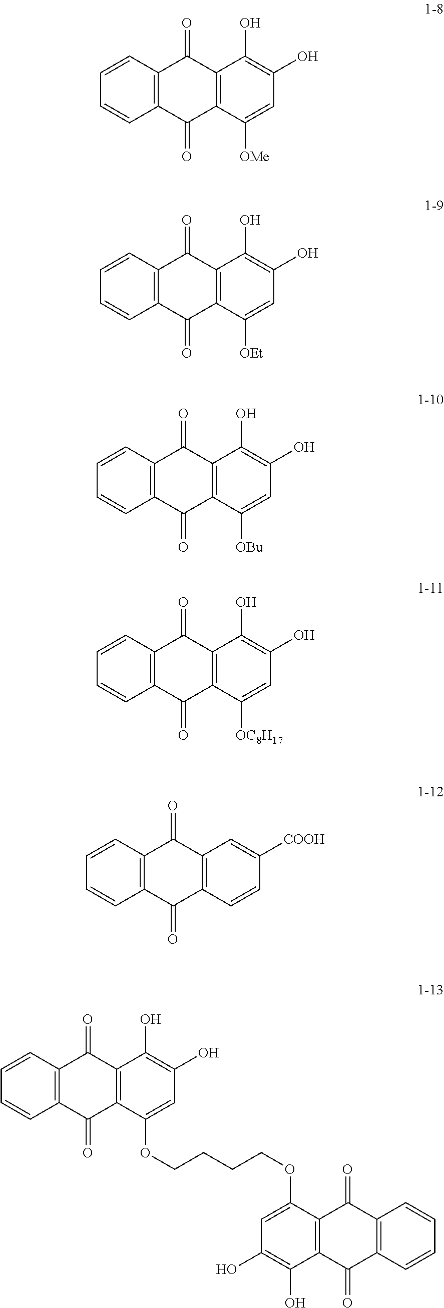

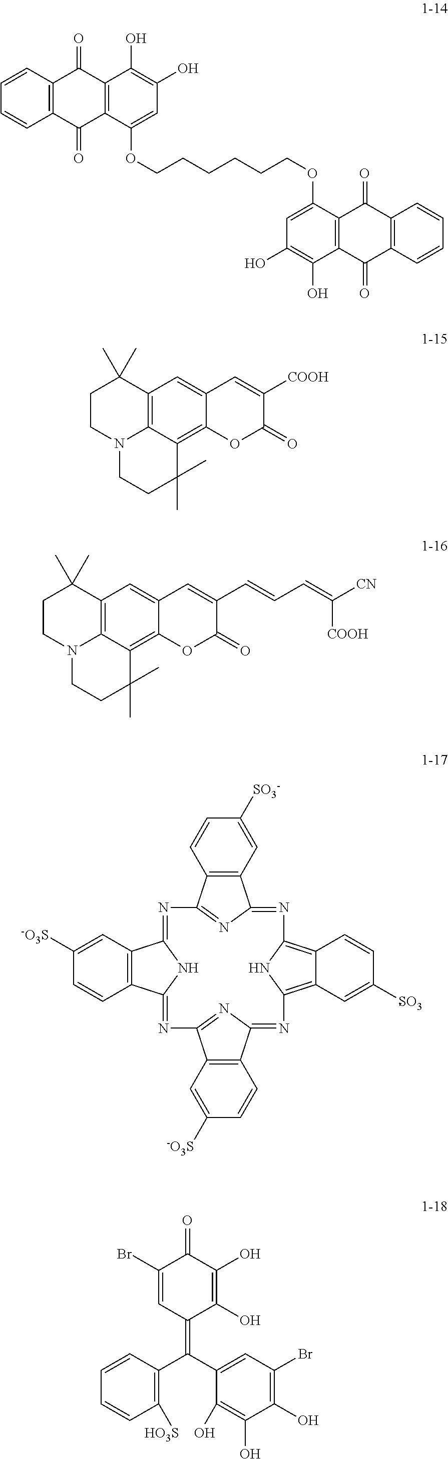

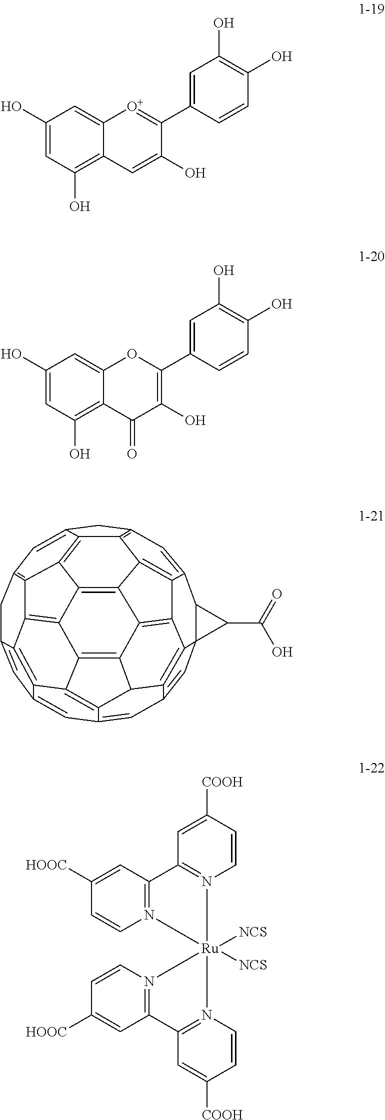

The content of the electron-accepting compound is generally preferably from 0.01% by weight to 20% by weight and more preferably from 0.1% by weight to 10% by weight although it is determined based on the surface area and content of the metal oxide particles, which are a counterpart for chemical reaction and adsorption, and the electron transport capability of each material.

When the content of the electron-accepting compound is less than 0.1% by weight, an effect of the electron-accepting compound may be difficult to obtain. On the other hand, when the content of the electron-accepting compound is greater than 20% by weight, the metal oxide particles easily aggregate each other and the distribution of the metal oxide particles in the undercoat layer is likely to be uneven. As a result, it may be difficult for a satisfactory conductive path to be formed. Therefore, the residual potential increases and ghosting occurs and furthermore the half-tone density may be uneven.

### Other Additives

Examples of other additives include resin particles. When a coherent light source such as a laser is used as an exposure device, it is preferable that moire fringe be prevented. To that end, it is preferable that the surface roughness of the undercoat layer be adjusted to be from ¼n (n represents the refractive index of an upper layer) to ½λ of a wavelength λ of exposure laser light to be used. The surface roughness may be adjusted by adding resin particles to the undercoat layer. Examples of the resin particles include silicone resin particles, crosslinked polymethylmethacrylate (PMMA) resin particles.

In addition, the additives are not limited thereto, and for example, well-known additives may be used.

### Formation of Undercoat Layer

When the undercoat layer is formed, an undercoat layer-forming coating solution, obtained by adding the above-described components to a solvent, is used. The undercoat layer-forming coating solution is obtained by preliminarily mixing or preliminarily dispersing the metal oxide particles and optionally the electron-accepting compound and the above-described additives with each other; and dispersing the resultant in the binder resin.

Examples of the solvent used for obtaining the undercoat layer-forming coating solution include well-known organic solvents, which may dissolve the above-described binder resins, such as alcohol solvents, aromatic solvents, halogenated hydrocarbon solvents, ketone solvents, ketone alcohol solvents, ether solvents, and ester solvents. These solvents may be use alone or as a mixture of two or more kinds.

As a method of dispersing the metal oxide particles in the undercoat layer-forming coating solution, a well-known dispersing method is used. Examples of the dispersing method include methods using a roll mill, a ball mill, a vibration ball mill, an attritor, a sand mill, a colloid mill, and a paint shaker.

Examples of a coating method of the undercoat layer-forming coating solution include well-known coating methods such as a dip coating method, a blade coating method, a wire bar coating method, a spray coating method, a bead coating method, an air knife coating method, a curtain coating method.

It is preferable that the Vickers hardness of the undercoat layer is from 35 to 50.

The thickness of the undercoat layer is preferably greater than or equal to 15 more preferably from 15 μm to 30 μm, and still more preferably from 20 μm to 25 μm from the viewpoint of suppressing image ghosting.

### Interlayer

Optionally, an interlayer is provided between, for example, the undercoat layer and the photosensitive layer in order to improve electrical characteristics, image quality, image quality maintainability, and an adhesive property of the photosensitive layer. In addition, the interlayer may be provided between the conductive substrate and the undercoat layer.

Examples of a binder resin used for the interlayer include polymer resin compounds such as acetal resins (for example, polyvinyl butyral), polyvinyl alcohol resins, caseins, polyamide resins, cellulose resins, gelatins, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins; and organometallic compounds containing zirconium, titanium, aluminum, manganese, or silicon atoms. These compounds may be used alone or as a mixture or a polycondensate of plural compounds. Among these, an organometallic compound containing zirconium or silicon is preferable from the viewpoints that the residual potential is low and changes in potential due to the environment is small and that changes in potential due to repetitive use is small.

When the interlayer is formed, an interlayer-forming coating solution, obtained by adding the above-described components to a solvent, is used.

Examples of a coating method for forming the interlayer include well-known methods such as a dip coating method, a push-up coating method, a wire bar coating method, a spray coating method, a blade coating method, a knife coating method, and a curtain coating method.

The interlayer has a function of improving coating properties of an upper layer and a function as an electrical blocking layer. When the thickness thereof is too great, an electrical barrier is too strong, which may lead to an increase in potential due to desensitization and repetitive use. Therefore, when the interlayer is formed, it is preferable the thickness thereof be set within a range of from 0.1 μl to 3 μm. In this case, the interlayer may be used as the undercoat layer.

### Charge Generation Layer

The charge generation layer contains a charge generation material and a binder resin. In addition, the charge generation layer may be configured by a vapor-deposited film of the charge generation material.

Examples of the charge generation material include phthalocyanine pigments such as metal-free phthalocyanine, chlorogallium phthalocyanine, hydroxygallium phthalocyanine, dichlorotin phthalocyanine, and titanyl phthalocyanine. In particular, preferable examples thereof include chlorogallium phthalocyanine crystal having distinctive diffraction peaks with respect to CuKα characteristic X-rays at Bragg angles (2θ±0.2°) of at least 7.4°, 16.6°, 25.5°, and 28.3°; metal-free phthalocyanine crystal having distinctive diffraction peaks with respect to CuKα characteristic X-rays at Bragg angles (2θ±0.2°) of at least 7.7°, 9.3°, 16.9°, 17.5°, 22.4°, and 28.8°; hydroxygallium phthalocyanine crystal having distinctive diffraction peaks with respect to CuKα characteristic X-rays at Bragg angles (2θ±0.2°) of at least 7.5°, 9.9°, 12.5°, 16.3°, 18.6°, 25.1°, and 28.3°; and titanyl phthalocyanine crystal having distinctive diffraction peaks with respect to CuKα characteristic X-rays at Bragg angles (2θ±0.2°) of at least 9.6°, 24.1°, and 27.2°. Other examples of the charge generation material include quinone pigments, perylene pigments, indigo pigments, bisbenzimidazole pigments, anthrone pigments, and quinacridone pigments. In addition, these charge generation materials may be used alone or as a mixture of two or more kinds.

Examples of the binder resin included in the charge generation layer include bisphenol A type or bisphenol Z type polycarbonate resins, acrylic resins, methacrylic resins, polyarylate resins, polyester resins, polyvinyl chloride resins, polystyrene resins, acrylonitrile-styrene copolymer resins, acrylonitrile-butadiene copolymer resins, polyvinyl acetate resins, polyvinyl formal resins, polysulfone resins, styrene-butadiene copolymer resins, vinylidene chloride-acrylonitrile copolymer resins, vinyl chloride-vinyl acetate-maleic anhydride resins, silicone resins, phenol-formaldehyde resins, polyacrylamide resins, polyamide resins, and poly-N-vinylcarbazole resins. These binder resins may be used alone or as a mixture of two or more kinds.

It is preferable that the mixing ratio of the charge generation material and the binder resin be, for example, from 10:1 to 1:10.

When the charge generation layer is formed, a charge generation layer-forming coating solution, obtained by adding the above-described components to a solvent, is used.

Examples of a method of dispersing particles (for example, particles of the charge generation material) in the charge generation layer-forming coating solution include methods using media dispersing machines such as a ball mill, a vibration ball mill, an attritor, a sand mill, a horizontal sand mill and media-less dispersing machines such as a stirrer, an ultrasonic disperser, a roll mill, and a high-pressure homogenizer. Examples of the high-pressure homogenizer include a collision type of dispersing a dispersion through liquid-liquid collision or liquid-wall collision in a high-pressure state; and a pass-through type of dispersing a dispersion by causing it to pass through a fine flow path in a high-pressure state.

Examples of a method of coating the charge generation layer-forming coating solution on the undercoat layer include a dip coating method, a push-up coating method, a wire bar coating method, a spray coating method, a blade coating method, a knife coating method, and a curtain coating method.

The thickness of the charge generation layer is set to be preferably from 0.01 μm to 5 μm and more preferably from 0.05 μm to 2.0 μm.

### Charge Transport Layer

The charge transport layer contains a charge transport material and optionally further contains a binder resin.

Examples of the charge transport material include hole transporting materials such as oxadiazole derivatives (for example, 2,5-bis(p-diethylaminophenyl)-1,3,4-oxadiazole), pyrazoline derivatives (for example, 1,3,5-triphenyl-pyrazoline and 1-[pyridyl-(2)]-3-(p-diethylaminostyryl)-5-(p-diethylamino styryl)pyrazoline), aromatic tertiary amino compounds (for example, triphenylamine, N,N′-bis(3,4-dimethylphenyl) biphenyl-4-amine, tri(p-methylphenyl)aminyl-4-amine, and dibenzylaniline), aromatic tertiary diamino compounds (for example, N,N′-bis(3-methylphenyl)-N,N′-diphenylbenzidine), 1,2,4-triazine derivatives (for example, 3-(4′-dimethylamino phenyl)-5,6-di-(4′-methoxyphenyl)-1,2,4-triazine), hydrazone derivatives (for example, 4-diethylaminobenzaldehyde-1,1-diphenylhydrazone), quinazoline derivatives (for example, 2-phenyl-4-styryl-quinazoline), benzofuran derivatives (for example, 6-hydroxy-2,3-di(p-methoxyphenyl)benzofuran), α-stilbene derivatives (for example, p-(2,2-diphenylvinyl)-N,N-diphenylaniline), carbazole derivatives (for example, enamine derivatives and N-ethylcarbazole), and poly-N-vinylcarbazole and derivatives thereof; electron transport materials such as quinone compounds (for example, chloranil and bromoanthraquinone), tetracyano quinodimethane compounds, fluorenone compounds (for example, 2,4,7-trinitrofluorenone and 2,4,5,7-tetranitro-9-fluorenone), xanthone compounds, and thiophene compounds; and polymers having, in the main chain or at a side chain, a group derived from any of the above compounds. These charge transport material may be used alone or in a combination of two or more kinds.

Examples of the binder resin included in the charge transport layer include insulating resins such as bisphenol A type or bisphenol Z type polycarbonate resins, acrylic resins, methacrylic resins, polyarylate resins, polyester resins, polyvinyl chloride resins, polystyrene resins, acrylonitrile-styrene copolymer resins, acrylonitrile-butadiene copolymer resins, polyvinyl acetate resins, polyvinyl formal resins, polysulfone resins, styrene-butadiene copolymer resins, vinylidene chloride-acrylonitrile copolymer resins, vinyl chloride-vinyl acetate-maleic anhydride resins, silicone resins, phenol-formaldehyde resins, polyacrylamide resins, polyamide resins, and chlorine rubber; and organic photoconductive polymers such as polyvinyl carbazole, polyvinyl anthracene, and polyvinyl pyrene. These binder resins may be used alone or as a mixture of two or more kinds.

It is preferable that the mixing ratio of the charge transport material and the binder resin be, for example, from 10:1 to 1:5.

The charge transport layer is formed using a charge transport layer-forming coating solution obtained by adding the above-described components to a solvent.

Examples of a method of coating the charge transport layer-forming coating solution on the charge generation layer include well-known methods such as a dip coating method, a push-up coating method, a wire bar coating method, a spray coating method, a blade coating method, a knife coating method, and a curtain coating method.

The thickness of the charge transport layer is set to be preferably from 5 μl to 50 μm and more preferably 10 μm to 40 μm.

### Protective Layer

Optionally, the protective layer may be provided on the photosensitive layer. For example, the protective layer is provided in order to prevent the charge transport layer from being chemically changed during charging when the photoreceptor has a laminated structure, or in order to further improve the mechanical strength of the photosensitive layer.

Therefore, it is preferable that the protective layer include a layer containing a crosslinked material (cured material). Examples of the layer include layers having well-known configurations such as a cured layer of a composition, which contains, for example, the reactive charge transport material and optionally further contains a curable resin, and a cured layer obtained by dispersing the charge transport material in a curable resin. In addition, the protective layer may be a layer obtained by dispersing the charge transport material in the binder resin.

The protective layer is formed using a protective layer-forming coating solution obtained by adding the above-described components to a solvent.

Examples of a method of coating the protective layer-forming coating solution on the charge generation layer include well-known methods such as a dip coating method, a push-up coating method, a wire bar coating method, a spray coating method, a blade coating method, a knife coating method, and a curtain coating method.

The thickness of the protective layer is set to be, for example, preferably from 1 μm to 20 μm and more preferably from 2 μn to 10 μm.

Single-Layer Type Photosensitive Layer

A single-layer type photosensitive layer (charge generation and charge transport layer) contains, for example, a binder resin, a charge generation material and a charge transport material. As these materials, the same materials as those of the description of the charge generation layer and the charge transport layer may be used.

In the single-layer type photosensitive layer, the content of the charge generation material is preferably from 10% by weight to 85% by weight and more preferably 20% by weight to 50% by weight. In addition, the content of the charge transport material is preferably from 5% by weight to 50% by weight.

A method of forming the single-layer type photosensitive layer is the same as the method of forming the charge generation layer or the charge transport layer. The thickness of the single-layer type photosensitive layer is preferably from 5 μm to 50 μm and more preferably from 10 μm to 40 μm.

### Others

In the electrophotographic photoreceptor according to the exemplary embodiment, various additives such as an antioxidant, a light stabilizer, and a thermal stabilizer may be added to the photosensitive layer or the protective layer in order to prevent deterioration of the photoreceptor due to ozone or acidic gas produced in an image forming apparatus or due to light or heat.

In addition, at least one kind of electron-accepting material may be added to the photosensitive layer or the protective layer in order to improve sensitivity, to reduce residual potential, and to reduce fatigue due to repetitive use.

In addition, when the photosensitive layer or the protective layer is formed, silicone oil may be added to the coating solutions, which form the respective layers, as a leveling agent so as to improve the smoothness of the coating films.

### Image Forming Apparatus

Next, an image forming apparatus according to an exemplary embodiment of the invention will be described.

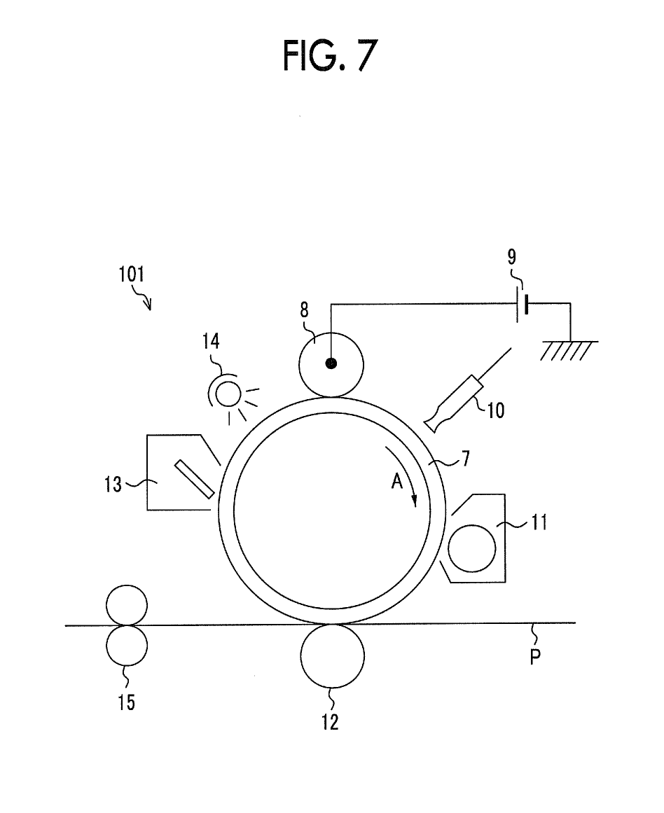

FIG. 7 is a diagram schematically illustrating a configuration example of the image forming apparatus according to the exemplary embodiment. An image forming apparatus 101 illustrated in FIG. 7 includes, for example, a drum-shaped (cylindrical) electrophotographic photoreceptor 7 according to the exemplary embodiment which is rotatably provided. In the vicinity of the electrophotographic photoreceptor 7, for example, a charging device 8, an exposure device 10, a developing device 11, a transfer device 12, a cleaning device 13, and an erasing device 14 are arranged in this order along a movement direction of an outer peripheral surface of the electrophotographic photoreceptor 7. The cleaning device 13 and the erasing device 14 are not necessarily provided.

### Charging Device

The charging device 8 is connected to a power supply 9. The power supply 9 applies a voltage to the charging device 8 and thereby charging a surface of the electrophotographic photoreceptor 7.

Examples of the charging device 8 include contact charging devices using a charging roller, a charging brush, a charging film, a charging rubber blade, a charging tube, and the like which are conductive. In addition, examples of the charging device 8 include non-contact roller charging devices and well-known charging devices such as a scorotron charger or corotron charger using corona discharge. As the charging device 8, contact charging devices are preferable.

### Exposure Device

The exposure device 10 exposes the charged electrophotographic photoreceptor 7 to light to form an electrostatic latent image on the electrophotographic photoreceptor 7.

Examples of the exposure device 10 include optical devices in which the surface of the electrophotographic photoreceptor 10 is exposed to light such as semiconductor laser light, LED light, and liquid crystal shutter light according to an image form. It is preferable that the wavelength of a light source fall within the spectral sensitivity range of the electrophotographic photoreceptor 10. It is preferable that the wavelength of a semiconductor laser light be in the near-infrared range having an oscillation wavelength of about 780 nm. However, the wavelength is not limited thereto. Laser light having an oscillation wavelength of about 600 nm or laser light having an oscillation wavelength of from 400 nm to 450 nm as blue laser light may be used. In addition, in order to form a color image, as the exposure device 30, for example, a surface-emitting laser light source of emitting multiple beams is also effective.

### Developing Device

The developing device 11 develops the electrostatic latent image using a developer to form a toner image. It is preferable that the developer contain toner particles having a volume average particle diameter of from 3 μm to 9 μm which are obtained with a polymerization method. For example, the developing device 11 has a configuration in which a developing roller, which is arranged opposite the electrophotographic photoreceptor 7 in a development region, is provided in a container which accommodates a two-component developer including a toner and a carrier.

### Transfer Device

The transfer device 12 transfers the toner image, formed on the electrophotographic photoreceptor 7, onto a transfer medium.

Examples of the transfer device 12 include contact transfer charging devices using a belt, a roller, a film, a rubber blade, and the like; and well-known transfer charging devices such as a scorotron transfer charger or a corotron transfer charger using corona discharge.

### Cleaning Device

The cleaning device 13 cleans toner remaining on the electrophotographic photoreceptor 7 after the toner image is transferred.

It is preferable that the cleaning device 13 include a cleaning blade which is in contact with the electrophotographic photoreceptor 7 at a linear pressure of from 10 g/cm to 150 g/cm. The cleaning device 13 includes, for example, a case, a cleaning blade, and a cleaning brush which is arranged downstream of the cleaning blade in a rotating direction of the electrophotographic photoreceptor 7. In addition, for example, the cleaning brush is in contact with a solid lubricant.

### Erasing Device

After the toner image is transferred, the erasing device irradiates the surface of the electrophotographic photoreceptor 7 with erasing light to erase a potential remaining on the surface of the electrophotographic photoreceptor. The erasing device 14 irradiates the entire surface of the electrophotographic photoreceptor 7 in the axial width direction with erasing light to remove a potential difference between an exposed portion which is caused by the exposure device 10 and a non-exposed portion on the surface of the electrophotographic photoreceptor 7.

A light source of the erasing device 14 is not particularly limited, and examples thereof include a tungsten lamp (which emits, for example, white light) and a light emitting diode (LED; which emits, for example, red light).

### Fixing Device

The image forming apparatus 100 includes a fixing device 15 which fixes the transferred toner image onto a recording paper P. The fixing device is not particularly limited, and examples thereof include well-known fixing devices such as heat roller fixing device and an oven fixing device.

Next, the operation of the image forming apparatus 101 according to the exemplary embodiment will be described. First, when the electrophotographic photoreceptor 7 rotates along a direction indicated by arrow A, the electrophotographic photoreceptor 7 is negatively charged by the charging device 8 at the same time.

A surface of the electrophotographic photoreceptor 7, which is negatively charged by the charging device 8, is exposed to light by the exposure device 10 to form an electrostatic latent image on the surface.

When a portion of the electrophotographic photoreceptor 7, on which the electrostatic latent image is formed, approaches the developing device 11, toner is attached onto the electrostatic latent image by the developing device 11 to form a toner image.

When the electrophotographic photoreceptor 7, on which the toner image is formed, rotates in the direction indicated by arrow A, the toner image is transferred onto the recording paper P by the transfer device 12. As a result, the toner image is formed on the recording paper P.

The toner image, which is formed on the recording paper P, is fixed thereon by the fixing device 15.

### Process Cartridge

The image forming apparatus according to the exemplary embodiment may have a configuration in which a process cartridge including the above-described electrophotographic photoreceptor 7 according to the exemplary embodiment is detachable from the image forming apparatus.

The process cartridge according to an exemplary embodiment of the invention is not limited as long as it includes the above-described electrophotographic photoreceptor 7 according to the exemplary embodiment. In addition to the electrophotographic photoreceptor 7, the process cartridge may further include, for example, at least one member selected from the charging device 8, the exposure device 10, the developing device 11, the transfer device 12, the cleaning device 13, and the erasing device 14.

In addition, the image forming apparatus according to the exemplary embodiment is not limited to the above-described configurations. For example, a first erasing device for aligning the polarity of remaining toner and facilitating the cleaning brush to remove the remaining toner may be provided downstream of the transfer device 12 in the rotating direction of the electrophotographic photoreceptor 7 and upstream of the cleaning device 13 in the rotating direction of the electrophotographic photoreceptor 7 in the vicinity of the electrophotographic photoreceptor 7; or a second erasing device for erasing the charge on the surface of the electrophotographic photoreceptor 7 may be provided downstream of the cleaning device 13 in the rotating direction of the electrophotographic photoreceptor 7 and upstream of the charging device 8 in the rotating direction of the electrophotographic photoreceptor 7.

In addition, the image forming apparatus according to the exemplary embodiment is not limited to the above-described configurations and well-known configurations may be adopted. For example, an intermediate transfer type image forming apparatus, in which the toner image, which is formed on the electrophotographic photoreceptor 7, is transferred onto an intermediate transfer medium and then transferred onto the recording paper P, may be adopted; or a tandem-type image forming apparatus may be adopted.

The electrophotographic photoreceptor according to the exemplary embodiment may be applied to an image forming apparatus which does not include the erasing device.

### EXAMPLES

Hereinafter, the exemplary embodiments will be described in further detail based on Examples and Comparative Examples, but the exemplary embodiments are not limited to the following examples.

### Example A

### Preparation of Conductive Substrate

### Conductive Substrate A1

A slag, which is formed of JIS 1050 alloy having an aluminum purity of 99.5% or higher and to which a lubricant is applied, is prepared, followed by homogenizing at 450° C. for 40 minutes. The homogenized slag is molded into a bottomed cylindrical member by impact pressing using a die (female) and a punch (male), followed by ironing. As a result, a cylindrical aluminum substrate having a diameter of 24 mm, a length of 251 mm, and a thickness of 0.5 mm is prepared. Then, the aluminum substrate is annealed at 220° C. for 60 minutes to obtain a conductive substrate A1.

The aluminum substrate obtained through the above-described processes is set as the conductive substrate A1.

### Conductive Substrates A2 to A13

Conductive substrates A2 to A13 are prepared with the same preparation method as that of the conductive substrate A1, except that the purity and heating conditions of the aluminum slag used is changed as shown in Table 1. The dimension of the substrate is adjusted by changing impact pressing conditions.

However, the conductive substrate A9 is cut into a cylindrical compact.

### Surface Treatment of Metal Oxide Particles

Surface Treatment Example A1

100 parts by weight of zinc oxide particles (trade name: MZ-300, manufactured by Tayca Corporation) as the metal oxide particles; 10 parts by weight of 10% by weight toluene solution of N-2 (aminoethyl)-3-aminopropyltrimethoxysilane as the coupling agent; and 200 parts by weight of toluene are mixed with each other, followed by stirring and reflux for 2 hours. Then, toluene is removed by distillation at 10 mmHg, followed by baking at 135° C. for 2 hours.

### Surface Treatment Examples A2 and A3

The surface treatments are performed with the same method as that of the surface treatment example 1, except that conditions are changed as shown in Table 2.

### Example A1

Formation of Undercoat Layer

33 parts by weight of zinc oxide particles of which the surfaces are treated in the surface treatment example 1, 6 parts by weight of blocked isocyanate SUMIDUR 3175 (manufactured by Sumitomo-Bayer Urethane Co., Ltd.), 0.7 parts by weight of electron-accepting compound (Exemplary Compound (1-6)), and 25 parts by weight of methyl ethyl ketone are mixed for 30 minutes. Then, 5 parts by weight of butyral resin S-LEC BM-1 (manufactured by Sekisui Chemical Co., Ltd.), 3 parts by weight of SILICONE BALL TOSPEARL 130 (manufactured by Toshiba Silicones Co., Ltd.), and 0.01 parts by weight of silicone oil SH29PA (manufactured by Dow Corning Toray Silicone Co., Ltd.) as the leveling agent are added thereto, followed by dispersion with a sand mill for 2 hours. As a result, a dispersion (undercoat layer-forming coating solution) is obtained.

Furthermore, the conductive substrate A1 is dip-coated with this coating solution, followed by drying and curing at 180° C. for 30 minutes. As a result, an undercoat layer having a thickness of 20 μm is formed.

### Formation of Charge Generation Layer

Next, 15 parts by weight of hydroxygallium phthalocyanine as the charge generation material, 10 parts by weight of vinyl chloride-vinyl acetate copolymer resin (VMCH, manufactured by Nippon Unicar Co., Ltd), and 300 parts by weight of n-butyl alcohol are mixed to obtain a mixture. The mixture is dispersed with a sand mill for 4 hours. The obtained dispersion is dip-coated on the undercoat layer, followed by drying at 100° C. for 10 minutes. As a result, a charge generation layer having a thickness of 0.2 μm is formed.

### Formation of Charge Transport Layer

Next, 4 parts by weight of N,N′-diphenyl-N,N′-bis(3-methylphenyl)-[1,1′]biphenyl-4,-diamine and 6 parts by weight of bisphenol Z polycarbonate resin (viscosity average molecular weight: 40,000) are dissolved in 25 parts by weight of tetrahydrofuran and 5 parts by weight of chlorobenzene to obtain a coating solution. This coating solution is coated on the charge generation layer, followed by drying at 130° C. for 40 minutes. As a result, a charge transport layer having a thickness of 35 μm is formed.

A photoreceptor is obtained through the above-described processes.

### Examples A2 to A12 and Comparative Example A1

Photoreceptors are obtained in the same preparation method as that of Example A1, except that the compositions of the conductive substrate and the undercoat layer are changed as shown in Table 3.

### Evaluation A

The photoreceptor obtained in each example is evaluated as follows.

### Evaluation of Conductive Substrate

The average area of crystal grains in the conductive substrate of the photoreceptor obtained in each example is obtained with the above-described method. The results thereof are shown in Table 1 and the like.

### Evaluation of Photoreceptor

The photoreceptor obtained in each example is evaluated for the peeling of the undercoat layer.

Specifically, the peeling of the undercoat layer is evaluated with a method in which the photoreceptor obtained in each example is mounted to DocuPrint C1100 (manufactured by Fuji Xerox Co., Ltd.); 500,000 10% half-tone images are continuously formed on sheets of A4 paper (manufactured by Fuji Xerox Co., Ltd., C2 paper) in an environment of 30° C. and 85% RH; and the peeling of the undercoat layer is visually inspected using an optical microscope based on the following criteria. The results are shown in Table 1 and the like.

The evaluation criteria are as follows.

A: Satisfactory (no peeling)
B: Slightly unsatisfactory, but no problems in practice (the peeling is observed outside an image area, but is not observed in the image)
C: Unusable (the peeling is observed over the entire surface)

Tables 1 to 3 show the details of the conductive substrates, the details of the surface treatments of the metal oxide particles, and the details of the respective Examples and Comparative Examples.

TABLE 1

| | Purity of | Heating Conditions | | Dimension | | | |
|---|---|---|---|---|---|---|---|
| | Slag Formed | Homogenizing | Annealing | Outer | | | Average Area of |
| | of Aluminum | Process of Slag | Process | Diameter | Length | Thickness | Crystal Grains |
| Conductive Substrate A1 | 99.5% | 450° C., 40 min | 220° C., 60 min | 24 mm | 251 mm | 0.5 mm | 1300 μm² |
| Conductive Substrate A2 | 99.5% | 450° C., 40 min | 215° C., 60 min | 24 mm | 251 mm | 0.5 mm | 1200 μm² |
| Conductive Substrate A3 | 99.5% | 450° C., 40 min | 220° C., 55 min | 24 mm | 251 mm | 0.5 mm | 1280 μm² |
| Conductive Substrate A4 | 99.5% | 450° C., 40 min | 215° C., 50 min | 24 mm | 251 mm | 0.3 mm | 1160 μm² |
| Conductive Substrate A5 | 99.5% | 450° C., 40 min | 215° C., 40 min | 24 mm | 251 mm | 0.7 mm | 1130 μm² |
| Conductive Substrate A6 | 99.5% | 450° C., 40 min | 220° C., 50 min | 24 mm | 251 mm | 0.5 mm | 1250 μm² |
| Conductive Substrate A7 | 99.5% | 450° C., 40 min | 210° C., 60 min | 24 mm | 251 mm | 0.5 mm | 1100 μm² |
| Conductive Substrate A8 | 99.5% | 450° C., 40 min | 220° C., 60 min | 24 mm | 251 mm | 0.5 mm | 1180 μm² |
| Conductive Substrate A9 | 99.5% | None | None | 24 mm | 251 mm | 0.5 mm | 90 μm² |
| Conductive Substrate A10 | 99.5% | 450° C., 40 min | 215° C., 45 min | 24 mm | 251 mm | 0.28 mm | 1150 μm² |
| Conductive Substrate A11 | 99.5% | 450° C., 40 min | None | 24 mm | 251 mm | 0.5 mm | 100 μm² |
| Conductive Substrate A12 | 99.5% | 450° C., 40 min | 210° C., 30 min | 24 mm | 251 mm | 0.5 mm | 500 μm² |
| Conductive Substrate A13 | 99.5% | 450° C., 40 min | 210° C., 50 min | 24 mm | 251 mm | 0.5 mm | 1000 μm² |

TABLE 2

| | Metal Oxide Particles | | | Coupling Agent | |
|---|---|---|---|---|---|
| Surface | | | Amount | | Amount of 10% by |
| Treatment | | | (Parts by | | Weight Toluene Solution |
| Example No. | Material | Trade Name | Weight) | Material | (Parts by Weight) |
| A1 | Zinc | MZ-300 (manufactured by | 100 | N-2(aminoethyl)-3- | 10 |
| | Oxide | Tayca Corporation) | | aminopropyltrimethoxysilane | |
| A2 | Titanium | TAF 500J (manufactured by | 100 | N-2(aminoethyl)-3- | 10 |
| | Oxide | Fuji Titanium Industry Co., Ltd.) | | aminopropyltrimethoxysilane | |
| A3 | Tin Oxide | S1 (manufactured by | 100 | N-2(aminoethyl)-3- | 10 |
| | | Mitsubishi Material Corporation) | | aminopropyltrimethoxysilane | |

TABLE 3

| | | | | Composition of Undercoat Layer | | | Evaluation |
|---|---|---|---|---|---|---|---|
| | Conductive Substrate | | | Metal Oxide Particles | | | Peeling of |
| | | | Average Area of | | Surface Treatment | Electron-Accepting Compound/ | Undercoat |
| | No. | Thickness | Crystal Grains | Material | Example No. | Parts by Weight | Layer |
| Example A1 | A1 | 0.5 mm | 1300 μm² | Zinc Oxide | A1 | 1-6/0.7 Parts by Weight | A |
| Example A2 | A2 | 0.5 mm | 1200 μm² | Titanium Oxide | A2 | 1-6/0.7 Parts by Weight | A |
| Example A3 | A3 | 0.5 mm | 1280 μm² | Tin Oxide | A3 | 1-6/0.7 Parts by Weight | A |
| Example A4 | A4 | 0.3 mm | 1160 μm² | Zinc Oxide | A1 | 1-6/0.7 Parts by Weight | A |
| Example A5 | A5 | 0.7 mm | 1130 μm² | Zinc Oxide | A1 | 1-6/0.7 Parts by Weight | A |
| Example A6 | A6 | 0.5 mm | 1250 μm² | Zinc Oxide | A1 | 1-9/1 Part by Weight | A |
| Example A7 | A7 | 0.5 mm | 1100 μm² | Zinc Oxide | A1 | 1-14/1 Part by Weight | A |
| Example A8 | A8 | 0.5 mm | 1180 μm² | Zinc Oxide | A1 | 1-21/1 Parts by Weight | A |
| Comparative | A9 | 0.5 mm | 90 μm² | Zinc Oxide | A1 | 1-6/0.7 Parts by Weight | C |
| Example A1 | | | | | | | |
| Example A9 | A10 | 0.28 mm | 1150 μm² | Zinc Oxide | A1 | 1-6/0.7 Parts by Weight | B |
| Example A10 | A11 | 0.5 mm | 100 μm² | Zinc Oxide | A1 | 1-6/0.7 Parts by Weight | B |
| Example A11 | A12 | 0.5 mm | 500 μm² | Zinc Oxide | A1 | 1-6/0.7 Parts by Weight | B |
| Example A12 | A13 | 0.5 mm | 1000 μm² | Zinc Oxide | A1 | 1-6/0.7 Parts by Weight | A |

In Table 3, “No” in the item “Conductive substrate” represents “No” in the item “Conductive substrate” of Table 1. For example, “A1” represents “Conductive Substrate A1”.

It can be seen from the above results that the peeling of the undercoat layers is suppressed in the Examples as compared to the Comparative Example.

### Examples B

### Preparation of Conductive Substrate

### Conductive Substrate B1

A slag, which is formed of JIS 1050 alloy having an aluminum purity of 99.5% or higher and to which a lubricant is applied, is prepared, followed by homogenizing at 450° C. for 40 minutes. The homogenized slag is molded into a bottomed cylindrical member by impact pressing using a die (female) and a punch (male), followed by ironing. As a result, a cylindrical aluminum substrate having a diameter of 24 mm, a length of 251 mm, and a thickness of 0.5 mm is prepared. However, the aluminum substrate is not annealed.

An aluminum substrate obtained through the above-described processes is set as a conductive substrate B1.

A compact obtained through the above-described processes is set as the conductive substrate B1.

### Conductive Substrates B2 to B9

Conductive substrates B2 to B9 are prepared with the same preparation method as that of the conductive substrate B1, except that the purity and heating conditions of the aluminum slag used are changed as shown in Table 4. The dimension of the substrate is adjusted by changing impact pressing conditions.

### Example B1

### Formation of Undercoat Layer

100 parts by weight of zinc oxide particles (average particle diameter: 70 nm, manufactured by Tayca Corporation, specific surface area: 15 m²/g) as the metal oxide particles is stirred and mixed with 500 parts by weight of tetrahydrofuran. 1.3 parts by weight of silane coupling agent (KBM 603, manufactured by Shin-Etsu Chemical Co., Ltd., N-2-(aminoethyl)-3-aminopropyltrimethoxysilane) as the coupling agent is added thereto, followed by stirring for 2 hours. Then, toluene is removed by distillation under reduced pressure, followed by baking at 120° C. for 3 hours. As a result, zinc oxide particles with the surfaces treated with the silane coupling agent are obtained.

110 parts by weight of the surface-treated zinc oxide particles is stirred and mixed with 500 parts by weight of tetrahydrofuran. A solution, obtained by dissolving 0.6 parts by weight of alizarin (Exemplary Compound (1-2)) as the electron-accepting compound in 50 parts by weight of tetrahydrofuran, is added thereto, followed by stirring at 50° C. for 5 hours. Then, zinc oxide particles to which alizarin is added are separated by filtration under reduced pressure, followed by drying under reduced pressure at 60° C. As a result, alizarin-added zinc oxide particles are obtained.

60 parts by weight of the alizarin-added zinc oxide particles, 13.5 parts by weight of curing agent (blocked isocyanate SUMIDUR 3175, manufactured by Sumitomo-Bayer Urethane Co., Ltd.), and 15 parts by weight of butyral resin (S-LEC BM-1, manufactured by Sekisui Chemical Co., Ltd.) are dissolved in 85 parts by weight of methyl ethyl ketone to obtain a solution. 38 parts by weight of the solution is mixed with 25 parts by weight of methyl ethyl ketone, followed by dispersion for 2 hours using a sand mill with 1 mmφ glass beads. As a result, a dispersion is obtained.

To this dispersion, as a catalyst, 0.005 parts by weight of dioctyl tin dilaurate and 40 parts by weight of silicone resin particles (TOSPEARL 145, manufactured by GE Toshiba Silicones Co., Ltd.) are added. As a result, an undercoat layer-forming coating solution is obtained. This coating solution is dip-coated on the aluminum substrate having a diameter of 30 mm, a length of 340 mm, and a thickness of 1 mm, followed by drying and curing at 170° C. for 40 minutes. As a result, an undercoat layer having a thickness of 19 μm is formed.

### Formation of Charge Generation Layer

Next, 15 parts by weight of hydroxygallium phthalocyanine, as the charge generation material, having diffraction peaks at Bragg angles (2θ±0.2° of at least 7.3°, 16.0°, 24.9°, and 28.0° in an X-ray diffraction spectrum using CuKα characteristic X-rays; 10 parts by weight of vinyl chloride-vinyl acetate copolymer resin (VMCH, manufactured by Nippon Unicar Co., Ltd.) as the binder resin, and 200 parts by weight of n-butyl acetate are mixed to obtain a mixture. The mixture is dispersed using a sand mill with glass beads having a diameter of 1 mmφ for 4 hours. 175 parts by weight of n-butyl acetate and 180 parts by weight of methyl ethyl ketone are added to the obtained dispersion, followed by stirring. As a result, a charge generation layer-forming coating solution is obtained. This charge generation layer-forming coating solution is dip-coated on the undercoat layer, followed by drying at room temperature (25° C.). As a result, a charge generation layer having a thickness of 0.2 μm is formed.

### Preparation of Charge Transport Layer

Next, 45 parts by weight of N,N′-diphenyl-N,N′-bis(3-methylphenyl)-[1,1′]biphenyl-4,4′-diamine and 55 parts by weight of bisphenol Z polycarbonate resin (viscosity average molecular weight: 50,000) are added to and dissolved in 800 parts by weight of chlorobenzene to obtain a charge transport layer-forming coating solution. This charge transport layer-forming coating solution is coated on the charge generation layer, followed by drying at 130° C. for 45 minutes. As a result, a charge transport layer having a thickness of 20 μm is formed.

### Examples 32 to 316 and Comparative Example B1

Photoreceptors are obtained in the same preparation method as that of Example A1, except that the compositions of the conductive substrate and the undercoat layer are changed as shown in Table 5.

In this case, titanium oxide (TIC₂) used in Example B5 is TAF 500J (manufactured by Fuji Titanium Industry Co., Ltd.); and tin oxide (SnO₂) used in Example B6 is S-1 (manufactured by Mitsubishi Material Corporation).

In addition, the coupling agent KBM 573 used in Example B7 is N-phenyl-3-aminopropyltrimethoxysilane (manufactured by Shin-Etsu Chemical Co., Ltd.); the coupling agent KBM 903 used in Example 38 is 3-aminopropyltriethoxysilane (manufactured by Shin-Etsu Chemical Co., Ltd.); and the coupling agent KBM 503 used in Example B16 is 3-methacryloxypropyltrimethoxysilane (manufactured by Shin-Etsu Chemical Co., Ltd.).

### Evaluation B

The photoreceptor obtained in each example is evaluated as follows.

### Evaluation of Conductive Substrate

The average area of crystal grains in the conductive substrate of the photoreceptor obtained in each example is obtained with the above-described method. The results thereof are shown in Table 4 and the like.

### Image Quality Evaluation

The photoreceptor obtained in each example is mounted to DocuCentre Color 400CP (manufactured by Fuji Xerox Co., Ltd.). Then, the evaluation for deterioration in image quality due to the progress of corrosion of the conductive substrate is continuously performed in an environment of 30° C. and 85% RH.

That is, 500,000 10% half-tone images are continuously formed on sheets of A4 paper (manufactured by Fuji Xerox Co., Ltd., C2 paper) for test in an environment of 30° C. and 85% RH. The first image is evaluated for unevenness in density and the 500,000th image is evaluated for point defects (color points) of image quality. The results thereof are shown in Table 5.

The respective evaluation criteria for the unevenness in density and the point defects of image quality are as follows.

A: Unevenness in image density or point defects of image quality are not observed at all
B: Unevenness in image density is slightly observed; or less than 3 of point defects of image quality are observed, but there are no problems in practice
C: Unevenness in image density is observed; or 3 or more and less than 5 of point defects of image quality are observed, but there are no problems in practice
D: Only a part of an image is recognized due to unevenness in image density; or 5 or more and less than 10 of point defects of image quality are observed
E: An image is not recognized at all due to unevenness in image density; or ten or more of point defects of image quality are observed in a wide region

### Evaluation for Peeling of Undercoat Layer

The photoreceptor obtained in each example is evaluated for the peeling of the undercoat layer.

Specifically, the peeling of the undercoat layer is evaluated with a method in which the photoreceptor obtained in each example is mounted to DocuPrint C1100 (manufactured by Fuji Xerox Co., Ltd.); 500,000 10% half-tone images are continuously formed on sheets of A4 paper (manufactured by Fuji Xerox Co., Ltd., C2 paper) in an environment of 30° C. and 85% RH; and the peeling of the undercoat layer is visually inspected using an optical microscope based on the following criteria. The results are shown in Table 5 and the like.

The evaluation criteria are as follows.

A: Satisfactory (no peeling)
B: Slightly unsatisfactory, but no problems in practice (the peeling is observed outside an image area, but is not observed in the image)
C: Unusable (the peeling is observed over the entire surface)

Tables 4 and 5 show the details of the conductive substrates, the details of the surface treatments of the metal oxide particles, and the details of the respective Examples and Comparative Example.

TABLE 4

| | Purity of Slag | Heating Conditions | | Dimension | | | |
|---|---|---|---|---|---|---|---|
| | Formed of | Homogenizing | Annealing | Outer | | | Average Area of |
| | Aluminum | Process of Slag | Process | Diameter | Length | Thickness | Crystal Grains |
| Conductive Substrate B1 | 99.5% | 480° C., 40 min | None | 24 mm | 251 mm | 0.5 mm | 100 μm² |
| Conductive Substrate B2 | 99.5% | 480° C., 40 min | 200° C., 30 min | 24 mm | 251 mm | 0.5 mm | 105 μm² |
| Conductive Substrate B3 | 99.5% | 480° C., 40 min | 200° C., 60 min | 24 mm | 251 mm | 0.5 mm | 108 μm² |
| Conductive Substrate B4 | 99.5% | 480° C., 40 min | 200° C., 120 min | 24 mm | 251 mm | 0.5 mm | 112 μm² |
| Conductive Substrate B5 | 99.9% | 480° C., 40 min | None | 24 mm | 251 mm | 0.5 mm | 100 μm² |
| Conductive Substrate B6 | 99.4% | 480° C., 40 min | None | 24 mm | 251 mm | 0.5 mm | 100 μm² |
| Conductive Substrate B7 | 99.5% | 480° C., 40 min | None | 2870 mm | 251 mm | 0.5 mm | 100 μm² |
| Conductive Substrate B8 | 99.5% | 480° C., 40 min | None | 34 mm | 251 mm | 0.5 mm | 100 μm² |
| Conductive Substrate B9 | 99.5% | 480° C., 40 min | None | 24 mm | 251 mm | 0.5 mm | 90 μm² |

TABLE 5

| | | | | | | | | | Evaluation | | |
|---|---|---|---|---|---|---|---|---|---|---|---|
| | Conductive Substrate | | | | Composition of Undercoat Layer | | | | | Defects (Point | |
| | | | | Average | Metal Oxide Particles | | | | Unevenness | Defects) of | |
| | | | | Area of | | Coupling Agent | | Electron- | in Density | Image Quality | Peeling of |
| | | | Outer | Crystal | | | Amino | Accepting | of First | of 500,000th | Undercoat |
| | No. | Purity | Diameter | Grains | Kind | Kind | Group | Compound | Image | Image | Layer |
| Example B1 | B1 | 99.5% | 24 mm | 100 μm² | Zinc Oxide | KBM 603 | Present | Alizarin | A | A | B |
| Example B2 | B2 | 99.5% | 24 mm | 105 μm² | Zinc Oxide | KBM 603 | Present | Alizarin | A | A | B |
| Example B3 | B3 | 99.5% | 24 mm | 108 μm² | Zinc Oxide | KBM 603 | Present | Alizarin | A | A | B |
| Example B4 | B4 | 99.5% | 24 mm | 112 μm² | Zinc Oxide | KBM 603 | Present | Alizarin | A | A | B |
| Example B5 | B1 | 99.5% | 24 mm | 100 μm² | Titanium | KBM 603 | Present | Alizarin | A | A | B |
| | | | | | Oxide | | | | | | |
| Example B6 | B1 | 99.5% | 24 mm | 100 μm² | Tin Oxide | KBM 603 | Present | Alizarin | A | A | B |
| Example B7 | B1 | 99.5% | 24 mm | 100 μm² | Zinc Oxide | KBM 573 | Present | Alizarin | A | A | B |
| Example B8 | B1 | 99.5% | 24 mm | 100 μm² | Zinc Oxide | KBM 903 | Present | Alizarin | A | A | B |
| Example B9 | B5 | 99.9% | 24 mm | 100 μm² | Zinc Oxide | KBM 603 | Present | Alizarin | A | A | B |
| Example B10 | B6 | 99.4% | 24 mm | 100 μm² | Zinc Oxide | KBM 603 | Present | Alizarin | B | A | B |
| Example B11 | B7 | 99.5% | 28 mm | 100 μm² | Zinc Oxide | KBM 603 | Present | Alizarin | B | A | B |
| Example B12 | B8 | 99.5% | 34 mm | 100 μm² | Zinc Oxide | KBM 603 | Present | Alizarin | B | A | B |
| Example B13 | B1 | 99.5% | 24 mm | 100 μm² | Zinc Oxide | KBM 603 | Present | Chloranil | A | B | B |
| Example B14 | B1 | 99.5% | 24 mm | 100 μm² | Zinc Oxide | KBM 603 | Present | None | A | C | B |
| Comparative | B9 | 99.5% | 24 mm | 90 μm² | Zinc Oxide | KBM 603 | Present | Alizarin | A | E | C |
| Example B1 | | | | | | | | | | | |
| Example B15 | B1 | 99.5% | 24 mm | 100 μm² | None | KBM 603 | Present | Alizarin | E | Not Evaluated | B |
| Example B16 | B1 | 99.5% | 24 mm | 100 μm² | Zinc Oxide | KBM 503 | None | Alizarin | E | Not Evaluated | B |

In Table 5, “No” in the item “Conductive substrate” represents “No” in the item “Conductive substrate” of Table 4. For example, “B1” represents “Conductive Substrate B1”.

It can be seen from the above results that the peeling of the undercoat layers is suppressed in the Examples as compared to the Comparative Example.

In addition, when Examples B1 and the like are compared to Comparative Example B1, it can be seen that, when the metal oxide particles, of the surfaces are treated with the coupling agent having an amino group, are used, the corrosion of the conductive substrate is difficult to progress and satisfactory results for point defects of image quality are obtained in the evaluation of the 500,000th image. In Example 16B in which metal oxide particles, of which the surfaces are treated with a coupling agent not having an amino group, are used, the corrosion of the conductive substrate is difficult to progress; whereas the unevenness in density of the first image deteriorates as compared to Example B1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a cylindrical conductive substrate that is formed of a metal or an alloy and has an average area of crystal grains of 100 μm² or greater; and
a photosensitive layer that is provided on the conductive substrate.

2. The electrophotographic photoreceptor according to claim 1,
wherein the average area of crystal grains in the conductive substrate is greater than or equal to 400 μm².

3. The electrophotographic photoreceptor according to claim 1,
wherein the average area of crystal grains in the conductive substrate is less than or equal to 1400 μm².

4. The electrophotographic photoreceptor according to claim 1, further comprising:
an undercoat layer that is provided between the conductive substrate and the photosensitive layer.

5. The electrophotographic photoreceptor according to claim 4,
wherein the undercoat layer contains a binder resin and metal oxide particles of which surfaces are treated with a coupling agent having an amino group.

6. The electrophotographic photoreceptor according to claim 1,
wherein the thickness of the conductive substrate is from 0.3 mm to 0.7 mm.

7. The electrophotographic photoreceptor according to claim 1,
wherein the thickness of the conductive substrate is from 0.4 mm to 0.6 mm.

8. The electrophotographic photoreceptor according to claim 1,
wherein the metal or the alloy that forms the conductive substrate is aluminum or an aluminum alloy.

9. The electrophotographic photoreceptor according to claim 8,
wherein the average area of crystal grains in the conductive substrate is greater than or equal to 400 μm².

10. The electrophotographic photoreceptor according to claim 8,
wherein the average area of crystal grains in the conductive substrate is less than or equal to 1400 μm².

11. The electrophotographic photoreceptor according to claim 8, further comprising:
an undercoat layer that is provided between the conductive substrate and the photosensitive layer.

12. The electrophotographic photoreceptor according to claim 11,
wherein the undercoat layer contains a binder resin and metal oxide particles of which surfaces are treated with a coupling agent having an amino group.

13. The electrophotographic photoreceptor according to claim 8,
wherein the thickness of the conductive substrate is from 0.3 mm to 0.7 mm.

14. The electrophotographic photoreceptor according to claim 8,
wherein the thickness of the conductive substrate is from 0.4 mm to 0.6 mm.

15. The electrophotographic photoreceptor according to claim 8,
wherein a content of aluminum in the conductive substrate is higher than or equal to 99.5%.

16. A process cartridge, which is detachable from an image forming apparatus, comprising:
the electrophotographic photoreceptor according to claim 1.

17. An image forming apparatus comprising:
the electrophotographic photoreceptor according to claim 1;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image, formed on the surface of the electrophotographic photoreceptor, using toner to form a toner image; and
a transfer unit that transfers the toner image, formed on the surface of the electrophotographic photoreceptor, onto a recording medium.
